(19) United States
(12) Patent Application Publication
(10) Pub. No.: US 2013/0293817 A1
(43) Pub. Date: Nov. 7, 2013

(54) LIQUID CRYSTAL DISPLAY DEVICE

(71) Applicants: Yuichi Kawahira, Osaka-shi (JP); Mitsuhiro Murata, Osaka-shi (JP); Toshihiro Matsumoto, Osaka-shi (JP)

(72) Inventors: Yuichi Kawahira, Osaka-shi (JP); Mitsuhiro Murata, Osaka-shi (JP); Toshihiro Matsumoto, Osaka-shi (JP)

(73) Assignee: Sharp Kabushiki Kaisha, Osaka-shi (JP)

(21) Appl. No.: 13/813,780

(22) PCT Filed: Jul. 26, 2011
(86) PCT No.: PCT/JP2011/066973

§ 371 Date: Jul. 8, 2013

(30) Foreign Application Priority Data
Aug. 2, 2010 (JP) 2010-173581

(51) Int. Cl. G02F 1/1343

(52) U.S. Cl. CPC G02F 1/1343
USPC 349/139

(57) ABSTRACT

A liquid crystal display device (10) includes an array substrate (20), a counter substrate (22), and a liquid crystal layer (60). Liquid crystal molecules (62) are initially aligned in the vertical direction, and the liquid crystal display device displays an image by controlling the liquid crystal molecules with a transverse electric field. A convex projection (42) is disposed on the array substrate (20), and a pixel electrode (24) is disposed to cover at least a part of a side surface (44) of the convex projection.

### TECHNICAL FIELD

The present invention relates to a liquid crystal display device in which reduction of display quality is suppressed.

### BACKGROUND ART

A liquid crystal display device including comb electrodes and displaying an image with a transverse electric field is known as related art.

(Patent Literature (PTL) 1)

For example, PTL 1 discloses a display device for displaying an image by driving a liquid crystal with an electric field that is generated between a pixel electrode and a counter electrode both disposed on the same substrate.

### CITATION LIST

### Patent Literature

PTL 1: Japanese Unexamined Patent Application Publication “Tokukaihei No. 11-64886 (Publication Date: Mar. 5, 1999)”

### SUMMARY OF INVENTION

### Technical Problem

In the above-described liquid crystal display device including the pixel electrode and the counter electrode both disposed on the same substrate, there is known a display mode in which an image is displayed by employing liquid crystal molecules vertically aligned when no voltage is applied. Such a display mode is called a TBA (Transverse Bend Alignment) mode hereinafter.

In the TBA mode, positive liquid crystal molecules are aligned in the vertical direction perpendicular to a pair of substrates, and a transverse electric field is generated between comb electrodes (pixel electrode and counter electrode), which are disposed on one of the substrates. An amount of light transmitting through a liquid crystal display device is controlled by tilting the liquid crystal molecules toward a direction parallel to the substrates (i.e., toward the horizontal direction).

An example of construction of the liquid crystal display device operating in the TBA mode will be described below with reference to the drawings. FIG. 21 is a sectional view illustrating a fundamental construction of the liquid crystal display device.

As illustrated in FIG. 21, the liquid crystal display device 10 has a structure that a liquid crystal layer 60 is sandwiched between two insulating substrates (i.e., an array substrate 20 and a counter substrate 22).

A pixel electrode 24 and a counter electrode 26 are alternately disposed in a comb-like shape (as comb electrodes) on the array substrate 20 with an interlayer insulating film 40 interposed between both the electrodes. More specifically, the pixel electrode 24 and the counter electrode 26 have the same width (electrode width: L). Those electrodes 24 and 26 are disposed on the interlayer insulating film 40 at a constant spacing (electrode spacing: S).

Furthermore, alignment films 50 and 52 are disposed on respective surfaces of the array substrate 20 and the counter substrate 22 on the side facing the liquid crystal layer 60.

In the liquid crystal display device 10 operating in the TBA mode, vertical alignment films are used as the alignment films 50 and 52. Furthermore, liquid crystal molecules 62 contained in the liquid crystal layer 60 are positive liquid crystal display molecules.

With the construction described above, in an initial alignment state where no voltage is applied between the comb electrodes, the liquid crystal molecules 62 are aligned in the direction perpendicular to the substrates. When voltage is applied between the comb electrodes, a transverse electric field is generated in the direction parallel or oblique to the substrates. Because the liquid crystal molecules 62 are positive liquid crystal molecules, the liquid crystal molecules 62 are tilted toward the direction parallel to the substrates with application of the voltage.

In the TBA mode, a display operation is performed in accordance with the above-described behaviors of the liquid crystal molecules 62.

(Dark Line)

The display operation in the TBA mode has a problem that a dark line (i.e., a portion where light does not transmit through) occurs when display is in a bright state. The problem is described below with reference to FIG. 22, i.e., a sectional view of the liquid crystal display device, illustrating aligned states of liquid crystal molecules. It is to be noted that TR in FIG. 22 represents a transmittance curve.

A dark line may occur in a region R1 above the electrode and a region R2 at a middle between the electrodes as illustrated in FIG. 22. The occurrence of such a dark line can be seen from a drop of the transmission curve TR in each of the regions R1 and R2.

Here, the region R1 above the electrode implies a layer region positioned above the pixel electrode 24 or the counter electrode 26 in the direction of thickness of the liquid crystal display device 10.

Moreover, the region R2 at the middle between the electrodes implies a layer region positioned above a midpoint and thereabout between the pixel electrode 24 and the counter electrode 26.

(Region R1 above Electrode)

First, the dark line occurring in the region R1 above the electrode is described.

When voltage is applied to the electrode, the direction of an electric field generated from an electrode interface is perpendicular to the electrode interface. Therefore, when the electrode (each of the pixel electrode 24 and the counter electrode 26) is flat as illustrated in FIG. 22, the direction of the electric field near the electrode interface is perpendicular to the array substrate 20 as indicated by an arrow D2 (direction of the electric field). A line D1 in FIG. 22 indicates an equipotential line.

Because the liquid crystal molecules 62 are positive liquid crystal molecules, the direction D2 of the electric field and the direction of the liquid crystal molecules 62 are parallel to each other.

FIG. 23 is a partial sectional view of the liquid crystal display device, the view illustrating the aligned states of the liquid crystal molecules near the electrode interface.

As illustrated in FIG. 23, in the vicinity of the pixel electrode 24, the direction D2 of the electric field is close to the direction perpendicular to the array substrate 20, i.e., to the vertical direction, and a transverse electric field is hard to generate. Accordingly, the direction of the liquid crystal molecules 62 to be aligned in the same direction as that D2 of the electric field is also vertical.

Thus, in the vicinity of the electrode interface, an effective transverse electric field is not generated and therefore the liquid crystal molecules 62 are not tilted. As a result, transmittance does not increase and a dark line tends to be observed there.

It is to be noted that, while FIG. 23 illustrates the pixel electrode 24 as an example of the electrode, the above discussion is similarly applied to the case where the electrode is the counter electrode 26.

(Region R2 at Middle between Electrodes)

A dark line occurring in the region R2 at the middle between the electrodes is described below. In the region R2 at the middle between the electrodes, a transverse electric field is easy to generate unlike the region R1 above the electrode.

However, because the liquid crystal molecules 62 are caused to tilt from both sides of the region R1 above the electrode, there is a tendency that the liquid crystal molecules 62 collide with each other and remain aligned in the vertical direction.

Thus, the transmittance does not increase at the middle between the electrodes and a dark line tends to be observed there.

As described above, in the TBA mode, a dark line tends to be observed near a central portion of the electrode (i.e., the region R1 above the electrode) for the reason that the direction of the electric field is not turned to be horizontal and hence the liquid crystal molecules are not tilted there.

Moreover, a dark line tends to be observed near a portion between the adjacent electrodes (i.e., the region R2 at the middle between the electrodes) for the reason that forces causing the liquid crystal molecules 62 to tilt leftwards and forces causing them to tilt rightwards are equal to each other at high probability and hence the liquid crystal molecules are not tilted.

The present invention has been made with intent to solve the problems described above, and an object of the present invention is to provide a liquid crystal display device in which the occurrence of a dark line is suppressed and transmittance is increased. In particular, an object of the present invention is to provide a liquid crystal display device in which transmittance is increased in the aforementioned region R1 above the electrode.

### Solution to Problem

To solve the above-mentioned problem, the liquid crystal display device of the present invention comprises:

a pair of substrates and a liquid crystal layer sandwiched between the pair of substrates,

the liquid crystal layer containing liquid crystal molecules that are initially aligned in a direction perpendicular to the substrates,

the liquid crystal display device displaying an image by controlling alignment of the liquid crystal molecules with a transverse electric field,

wherein a projection formed of a dielectric substance is disposed on at least one of the pair of substrates, and

an electrode is disposed to cover at least a part of a side surface of the projection.

With the above-described feature, since the electrode is disposed on the side surface of the projection, the transverse (oblique) electric field is apt to generate near the electrode interface. Therefore, the liquid crystal molecules are apt to tilt toward the transverse (oblique) direction and transmittance increases near the electrode interface.

Accordingly, a liquid crystal display device having increased transmittance, particularly increased transmittance near the electrode, can be realized.

### Advantageous Effects of Invention

In the liquid crystal display device of the present invention, as described above, the projection formed of a dielectric substance is disposed on at least one of the pair of substrates, and the electrode is disposed to cover at least a part of the side surface of the projection.

Therefore, advantageous effects can be obtained in points of suppressing the occurrence of a dark line and realizing a liquid crystal display device having increased transmittance.

### BRIEF DESCRIPTION OF DRAWINGS

FIG. 1 illustrates an embodiment of the present invention and is a sectional view illustrating a fundamental construction of a liquid crystal display device.

FIG. 2 illustrates the embodiment of the present invention and is a sectional view of the liquid crystal display device, the view illustrating aligned states of liquid crystal molecules and transmittance.

FIG. 3 illustrates the embodiment of the present invention and is a partial sectional view of the liquid crystal display device, the view illustrating the aligned states of the liquid crystal molecules near an electrode interface.

FIG. 4 illustrates the embodiment of the present invention and is a graph depicting relation between a base angle θ and transmittance at L:S=4.0:4.0 μm.

FIG. 5 illustrates the embodiment of the present invention and is a graph depicting relation between the base angle θ and transmittance at L:S=2.5:5.5 μm.

FIG. 6 is an illustration to explain a range of the base angle θ; specifically, FIG. 6(a) is a numerical formula expressing relation between an electrode width L and a height H of a convex projection, FIG. 6(b) illustrates a model of the convex projection corresponding to the numerical formula, and FIG. 6(c) expresses a preferable range of the base angle θ.

FIG. 7 illustrates the embodiment of the present invention and is a graph depicting relation between setting of both the electrode width L and an electrode spacing S and an increase extent of transmittance.

FIG. 8 illustrates the embodiment of the present invention and is a graph depicting relation between a ratio of convex projection height H/cell gap d and transmittance at L:S=4.0:4.0 μm.

FIG. 9 illustrates the embodiment of the present invention and is a graph depicting relation between the ratio of convex projection height H/cell gap d and transmittance at L:S=2.5:5.5%.

FIG. 10 illustrates the embodiment of the present invention and is a partial sectional view of the liquid crystal display device; specifically, FIG. 10(a) illustrates the case where an electrode extends out of the convex projection, and FIG. 10(b) illustrates the case where the electrode does not fully cover the convex projection.

FIG. 11 is a sectional view of the convex projection to explain dimensions of the convex projection.

FIG. 12 illustrates a second embodiment of the present invention and is a sectional view illustrating a fundamental construction of a liquid crystal display device.

FIG. 13 illustrates the second embodiment of the present invention and is a sectional view of the liquid crystal display device, the view illustrating aligned states of liquid crystal molecules and transmittance.

FIG. 14 illustrates a comparative example and is a sectional view illustrating a fundamental construction of a liquid crystal display device.

FIG. 15 illustrates the comparative example and is a sectional view of the liquid crystal display device, the view illustrating aligned states of liquid crystal molecules and transmittance.

FIG. 16 illustrates the second embodiment of the present invention and is a graph depicting relation between the base angle θ and transmittance at L:S=4.0:4.0 μm.

FIG. 17 illustrates the second embodiment of the present invention and is a graph depicting relation between the base angle θ and transmittance at L:S=2.5:5.5 μm.

FIG. 18 illustrates the second embodiment of the present invention and is a graph depicting relation between the ratio of convex projection height H/cell gap d and transmittance at L:S=4.0:4.0 μm.

FIG. 19 illustrates the second embodiment of the present invention and is a graph depicting relation between the ratio of convex projection height H/cell gap d and transmittance at L:S=2.5:5.5 μm.

FIG. 20 illustrates the second embodiment of the present invention and is a partial sectional view of the liquid crystal display device; specifically, FIGS. 20(a) and 20(b) illustrate the case where the convex projection is rectangular, and FIGS. 20(c) and 20(d) illustrate the case where the convex projection is triangular.

FIG. 21 is a sectional view illustrating a fundamental construction of a liquid crystal display device.

FIG. 22 is a sectional view of the liquid crystal display device, the view illustrating aligned states of liquid crystal molecules and transmittance.

FIG. 23 is a partial sectional view of the liquid crystal display device, the view illustrating the aligned states of the liquid crystal molecules near an electrode interface.

### DESCRIPTION OF EMBODIMENTS

In the following, embodiments of the present invention will be described in detail.

### Embodiment 1

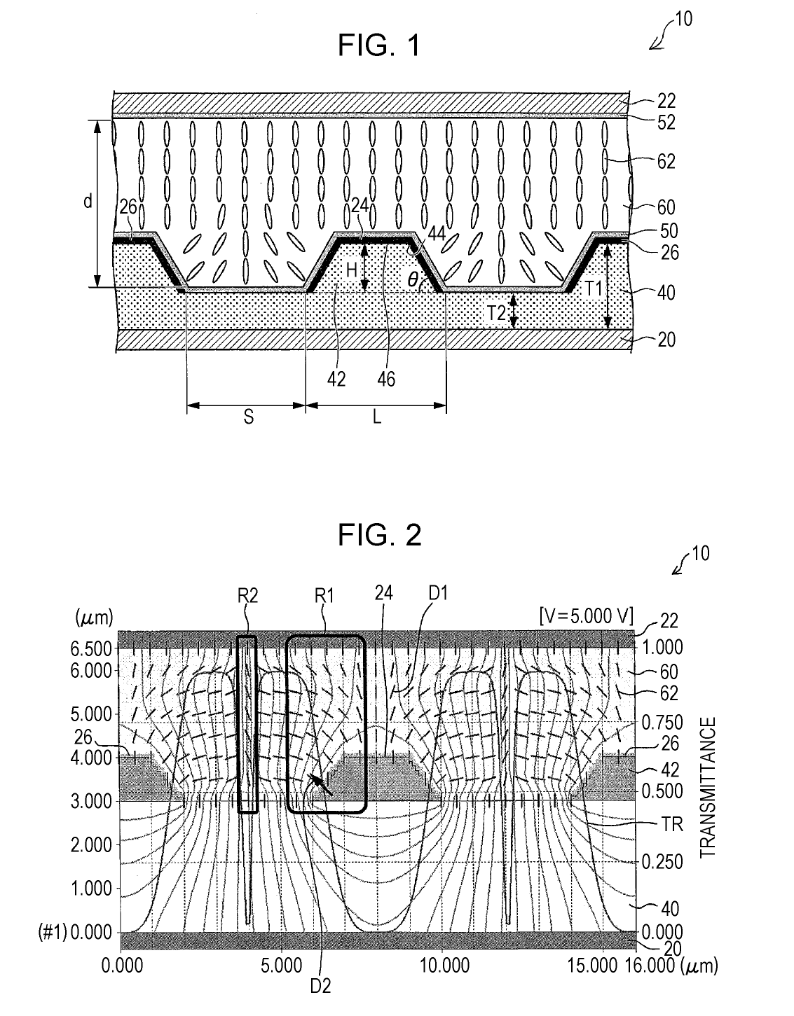

A first embodiment of the present invention is described below with reference to FIGS. 1 to 11.

FIG. 1 is a sectional view of a liquid crystal display device 10, illustrating the embodiment of the present invention.

A liquid crystal display device 10 of this embodiment is featured in that a convex projection (convex structure) 42 having a trapezoidal sectional shape is formed by an interlayer insulating film 40.

(Fundamental Construction)

As illustrated in FIG. 1, the liquid crystal display device 10 of this embodiment has a structure that a liquid crystal layer 60 containing positive liquid crystal molecules 62 is sandwiched between a pair of insulating substrates (i.e., an array substrate 20 and a counter substrate 22). The term “positive liquid crystal molecules” implies liquid crystal molecules having positive dielectric anisotropy Δ∈.

Furthermore, alignment films 50 and 52 are disposed on respective surfaces of the array substrate 20 and the counter substrate 22 on the side facing the liquid crystal layer 60.

Because the liquid crystal display device 10 of this embodiment is similar to the above-described liquid crystal display device 10 operating in the TBA mode, vertical alignment films are used as the alignment films 50 and 52. The term “vertical alignment film” implies an alignment film causing the liquid crystal molecules to vertically orient in a direction perpendicular to a film surface. The vertical alignment film can be made of suitable one of various materials including, e.g., organic materials and inorganic materials.

On example of the organic materials for the vertical alignment film is a polymer linked with a side chain having a vertical alignment property (i.e., a property of causing the liquid crystal molecules to vertically align (orient) in the direction perpendicular to the substrate). In other words, the vertical alignment film can be made of a material in which a group having the vertical alignment property is linked as a side chain to a polymer main chain.

As another example, a side chain having a photoreactive functional group may also be used as the above-mentioned side chain having the vertical alignment property. One example of the photoreactive functional group is a cinnamate group expressed by (Chemical Formula 1) given below.

Moreover, the photoreactive functional group may constitute a side chain by itself alone, or may constitute a part of a side chain. When the photoreactive functional group constitutes a part of a side chain, the photoreactive functional group may be arranged in any portion of the side chain.

It is to be noted that, when a polymer having the photoreactive functional group is used as the alignment film, an alignment process with the alignment film can be performed by illumination using light.

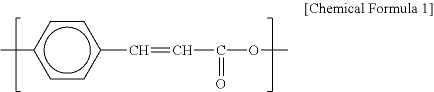

Electrodes (pixel electrode 24 and counter electrode 26) are disposed in a comb-like shape on the array substrate 20 with the interlayer insulating film 40 interposed between the adjacent electrodes.

The interlayer insulating film 40 is made of a dielectric substance, e.g., an acrylic resin.

In more detail, the pixel electrode 24 and the counter electrode 26 are alternately disposed. In FIG. 1, the pixel electrode 24 and the counter electrode 26 have the same electrode width L when viewed from above, and the adjacent electrodes are arranged at an electrode spacing S therebetween.

Active elements, such as TFTs (Thin Film Transistors), are also disposed on the array substrate 20.

[Convex Projection]

In the liquid crystal display device 10 of this embodiment, the convex projection 42 is disposed in the projected form between the array substrate 20 and the electrode. While a material of the convex projection 42 is not limited to particular one, the convex projection 42 is formed by the interlayer insulating layer 40 in the liquid crystal display device 10 of this embodiment.

Stated another way, the thickness of the interlayer insulating film 40 differs between a portion where the electrode is disposed and a portion where the electrode is not disposed.

In more detail, the thickness of the interlayer insulating film 40 between the adjacent electrodes is T2 (thickness of the interlayer insulating film between the electrodes), whereas the thickness of the interlayer insulating film 40 in a layer under the electrode (i.e., in a layer between the electrode and the array substrate 20) is T1 (thickness of the interlayer insulating film under the electrode).

Furthermore, H, i.e., a difference between the thickness T1 of the interlayer insulating film between the electrodes and the thickness T2 of the interlayer insulating film under the electrode, represents the height of the convex projection 42 (convex projection height H).

The convex projection 42 has a trapezoidal sectional shape. In other words, a side surface (convex-projection side surface) 44 of the convex projection 42 is inclined from the vertical direction perpendicular to the array substrate 20.

In this embodiment, as illustrated in FIG. 1, the convex projection 42 has a sectional shape of an isosceles trapezoid, for example. An angle formed between the convex-projection side surface 44 and the array substrate 20 is defined as a base angle θ.

(Electrode)

The electrode (each of the pixel electrode 24 and the counter electrode 26) in this embodiment is formed on not only an upper surface (convex-projection upper surface 46) of the convex projection 42, but also on the convex-projection side surface 44.

Thus, the electrode is disposed on portions of the trapezoid corresponding to an upper base and both legs thereof.

The electrode is not always required to be disposed over an entire surface of the convex projection 42 (i.e., fully over the upper base and both the legs thereof (or over the entire surface thereof in contact with the liquid crystal layer)). Transmittance can be increased by disposing the electrode at least on a part of the convex-projection side surface 44. An increase of the transmittance facilitates driving at a lower voltage. Such a point is described below.

(Alignment of Liquid Crystal Molecules)

FIG. 2 is a sectional view of the liquid crystal display device 10, the view illustrating aligned states of the liquid crystal molecules 62 in the liquid crystal display device 10 of this embodiment.

FIG. 2 is similar to FIG. 22 described above and illustrates alignment of the liquid crystal molecules 62, etc. when voltage is applied to the electrode. TR in FIG. 2 represents a transmittance curve.

The liquid crystal display device 10 of this embodiment is featured, as described above, in that the convex projection 42 is disposed and the electrode is disposed on the side surfaces of the convex projection 42, i.e., on the convex-projection side surfaces 44, as well.

When voltage is applied to the electrode, the direction of an electric field generated from an electrode interface is perpendicular to the electrode interface. In the above-described liquid crystal display device 10, the convex projection 42 has the trapezoidal shape. Therefore, the convex-projection side surfaces 44 are inclined from the vertical direction perpendicular to the array substrate 20, i.e., from the direction of thickness of the liquid crystal layer 60. The electrode is disposed on the convex-projection side surfaces 44.

Accordingly, the direction of the electric field, denoted by an arrow D2 in FIG. 2, tends to orient in the transverse direction (oblique direction) rather than in the vertical direction.

In the liquid crystal display device 10 operating in the TBA mode, since the liquid crystal molecules 62 are of the positive type, the direction D2 of the electric field and the direction of the liquid crystal molecules 62 are substantially parallel to each other. In the liquid crystal display device 10 of this embodiment, therefore, the liquid crystal molecules 62 tend to tilt near the electrode interface.

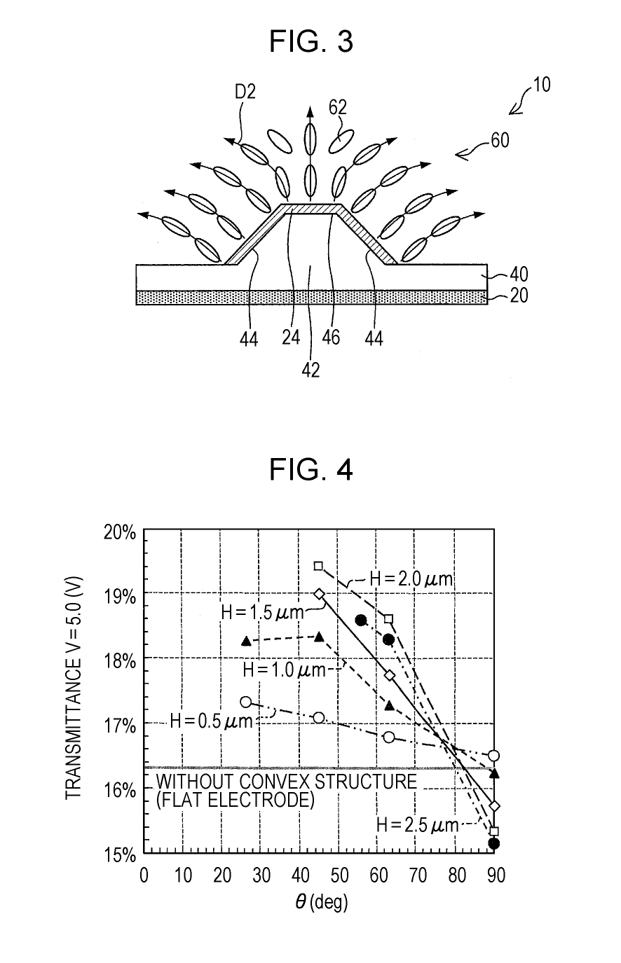

Such a point is described with reference to FIG. 3. FIG. 3 illustrates this embodiment and is a partial sectional view of the liquid crystal display device 10, the view illustrating the aligned states of the liquid crystal molecules 62 near the electrode interface.

As illustrated in FIG. 3, the direction D2 of the electric field is transverse near the electrode interface, particularly near the convex-projection side surface 44. Correspondingly, the direction of the liquid crystal molecules 62, which are caused to align in the same direction as that D2 of the electric field, is also tilted toward a direction parallel to the array substrate 20.

As a result, in the liquid crystal display device 10 of this embodiment, transmittance increases in the above-mentioned region R1 above the electrode where a dark line occurs and transmittance tends to reduce. In particular, since a transverse electric field is more apt to generate near both ends of the electrode, the transmittance is more apt to increase there. It is to be noted that, while FIG. 3 illustrates the pixel electrode 24 as an example of the electrode, the above discussion is similarly applied to the case where the electrode is the counter electrode 26.

Thus, in the liquid crystal display device 10 of this embodiment, the transmittance increases in the region R1 above the electrode.

Moreover, the transmittance increases in the region R2 at the middle between the electrodes as well for the reason that the transverse electric field near the electrode interface increases and hence forces causing the liquid crystal molecules 62 to align in the transverse direction also increase.

Such an increase of the transmittance in the region R1 above the electrode and the region R2 at the middle between the electrodes can be seen by comparing the transmittance curve TR between FIG. 2 and FIG. 22.

More specifically, comparing the transmittance curve TR in the region R1 above the electrode between FIG. 2 and FIG. 22, it is seen that the transmittance curve TR in FIG. 2 has a higher shoulder in its mountain-like shape, thus resulting in higher transmittance.

Likewise, comparing the transmittance curve TR in a portion near the region R2 at the middle between the electrodes between FIG. 2 and FIG. 22, it is seen that the transmittance curve TR in FIG. 2 maintains a higher position up to a point closer to the region R2 at the middle between the electrodes, thus resulting in higher transmittance near the region R2 at the middle between the electrodes.

In the liquid crystal display device 10 of this embodiment, as described above, the convex projection 42 is disposed as a convex structure and the convex structure is covered with the electrode. Therefore, the direction of the electric field near side surfaces of the convex structure can be made transverse or oblique.

Accordingly, the transverse electric field is more apt to generate near the side surfaces of the convex structure, which correspond to end portions of the electrode. Thus, in a display ON-state, a dark line is harder to generate and the transmittance is more apt to increase.

As a result, the transmittance increases in the liquid crystal display device 10 as a whole.

(Example of Dimensions)

An example of dimensions of the liquid crystal display device 10 of this embodiment is described below.

The cell gap d, the electrode width L, and the electrode spacing S, illustrated in FIG. 1 and so on, can be set to values similar to those generally set in the TBA mode. The cell gap d is equal to the thickness of the liquid crystal layer 60 in its portion where the convex projection 42 is not present.

More specifically, for example, the cell gap d can be set to about 3.5 μm, the electrode spacing (space) S can be set to 4 to 10 μm, and the electrode width (line) L can be set to 2.5 to 4 μm.

Parameters featuring the shape of the convex projection 42, i.e., the convex projection height H and the base angle θ, are described below.

The following description is premised on using materials and arrangements as follows: refractive index anisotropy Δn of the liquid crystal material=0.1, dielectric anisotropy Δ∈ of the liquid crystal material=22, thickness T1 of the interlayer insulating film under the electrode=3.0 μm, dielectric constant of the interlayer insulating film=3.3, and cell gap d=3.5 μm.

(L:S=4.0:4.0 μm)

FIG. 4 represents dependency of transmittance upon the base angle (base angle of the electrode) 8 on condition of the electrode width L=4.0 μm, the electrode spacing S=4.0 μm, and applied voltage=5.0 V. FIG. 4 is a graph depicting relation between the base angle θ and transmittance at L:S=4.0:4.0 μm.

As seen from FIG. 4, the transmittance increases regardless of a value of the convex projection height H as the base angle θ reduces from 90 degrees.

Furthermore, when a value of the base angle θ is the same, the transmittance tends to increase as the convex projection height H increases.

(L:S=2.5:5.5 μm)

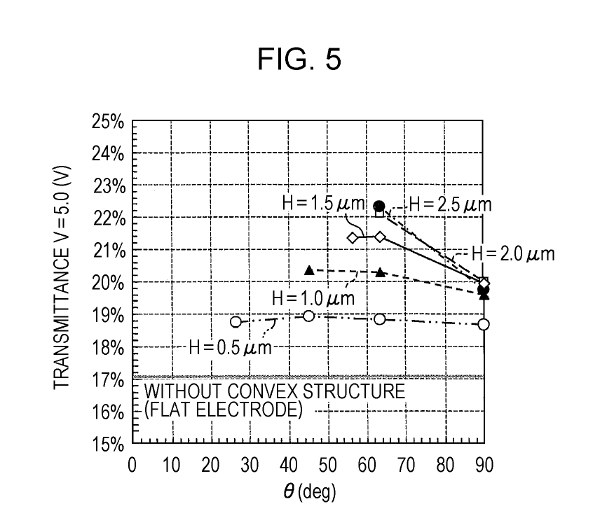

FIG. 5 represents dependency of the transmittance upon the base angle (base angle of the electrode) 8 on condition of the electrode width L=2.5 μm, the electrode spacing S=5.5 μm, and applied voltage=5.0 V. FIG. 5 is a graph, similar to that of FIG. 4, depicting relation between the base angle θ and transmittance at L:S=2.5:5.5 μm.

As seen from FIG. 5, in the case of L:S=2.5:5.5 μm, the transmittance tends to increase as the base angle θ reduces from 90 degrees as in the case of L:S=4.0:4.0 μm. Such a tendency is stronger at a higher value of the convex projection height H.

Furthermore, as in the case of L:S=4.0:4.0 μm, there is a tendency that when a value of the base angle θ is the same, the transmittance increases as the convex projection height H increases.

(Range of Base Angle θ)

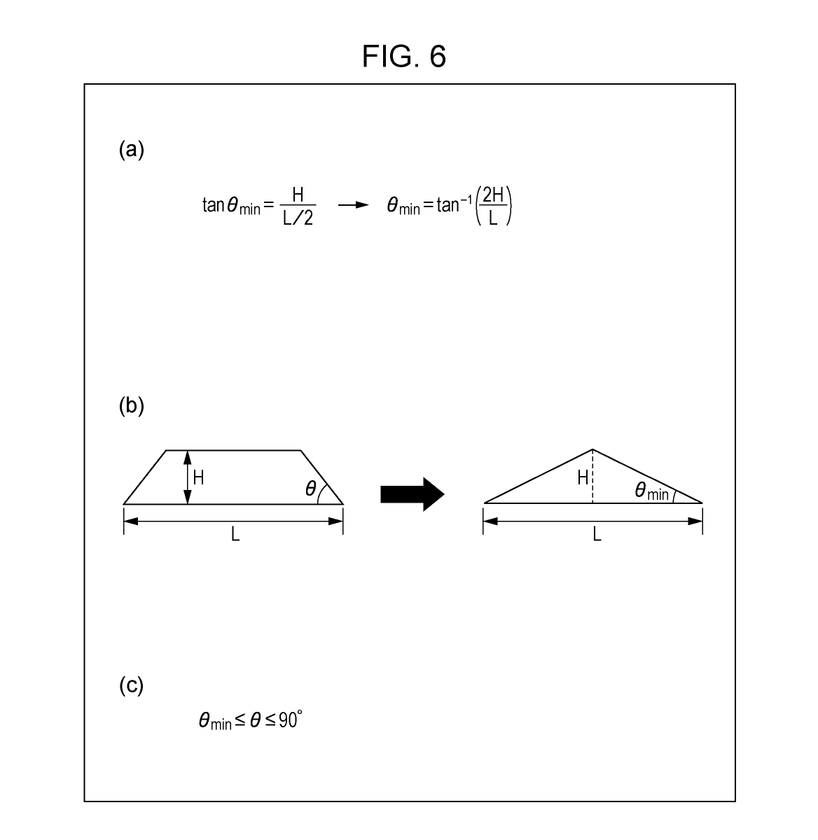

As depicted in FIGS. 4 and 5, there is a tendency that the effect of improving the transmittance increases regardless of the convex projection height H as the base angle θ reduces from 90 degrees. As understood from FIG. 6(b), however, a value of the base angle θ is limited with respect to the convex projection height H within a range where the convex structure of the convex projection can take a triangular shape. Given that a minimum value of the base angle θ is θmin, θmin can be expressed by a formula of FIG. 6(a).

Thus, as expressed in FIG. 6(c), a preferable range of the base angle θ is from θmin to 90 degrees.

FIGS. 6(a) to 6(c) are illustrations to explain a range of the base angle θ. Specifically, FIG. 6(a) is a numerical formula expressing relation between the electrode width L and the convex projection height H, FIG. 6(b) illustrates a model of the convex projection corresponding to the numerical formula, and FIG. 6(c) expresses the preferable range of the base angle θ.

(In Case of θ=90 Degrees)

In the case of L:S=4.0:4.0 μm depicted in FIG. 4, at the base angle θ=90 degrees, the transmittance reduces as the convex projection height H increases.

The reason is thought as follows. Increasing the convex projection height H while holding the base angle θ=90 degrees implies that the cell gap d in an electrode area is just reduced in a state where the oblique electric field is not generated. Therefore, retardation significantly departs from the so-called 1/2 condition, and the transmittance reduces in the electrode area.

Thus, by setting L:S such that a ratio of the electrode area to the entire area takes a small value, the transmittance can be obtained at a larger value than in the case of a flat electrode (reference) without including the convex projection, i.e., the convex structure, even when the convex projection height H is increased at the base angle θ=90 degrees.

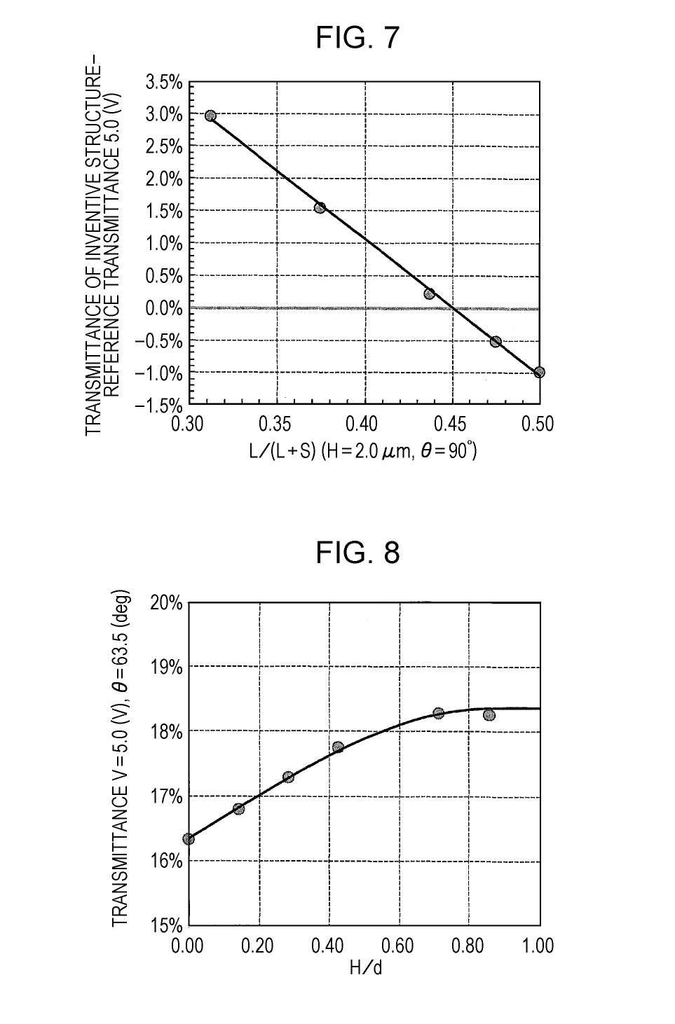

(L:S) providing the above-mentioned small ratio of the electrode area to the entire area is described below with reference to FIG. 7. FIG. 7 is a graph depicting relation between setting of both the electrode width L and the electrode spacing S and an increase extent of the transmittance. More specifically, FIG. 7 depicts relation between L/(L+S) and an increase extent of the transmittance (transmittance of the inventive structure−reference transmittance) at the applied voltage=5 V on condition of the convex projection height H=2.0 μm and the base angle θ=90 degrees. The transmittance of the inventive structure implies the transmittance in the liquid crystal display device including the convex projection according to this embodiment, whereas the reference transmittance implies the transmittance in a liquid crystal display device including the flat electrode without the convex projection.

As seen from FIG. 7, when L/(L+S) is reduced and a ratio of the electrode area to the entire area is reduced, specifically when L/(L+S) is reduced to be smaller than about 0.45, higher transmittance than that in the liquid crystal display device including the flat electrode can be obtained even when the convex projection height H is increased at the base angle θ=90 degrees.

(Setting of L:S)

While respective values of the electrode width L and the electrode spacing S are not limited to particular ones, the values in the above-described examples are given on the assumption of the case where the sum of the electrode width L and the electrode spacing S is 8 μm. An upper limit of the electrode width L is 4.0 μm and a lower limit thereof is 2.5 μm.

The reason is that, if the electrode width L exceeds above 4.0 μm, a transmittance loss increases due to reduction of an aperture ratio, and that, if the electrode width L exceeds below 2.5 μm, a problem may arise in mass productivity.

(Convex Projection Height H)

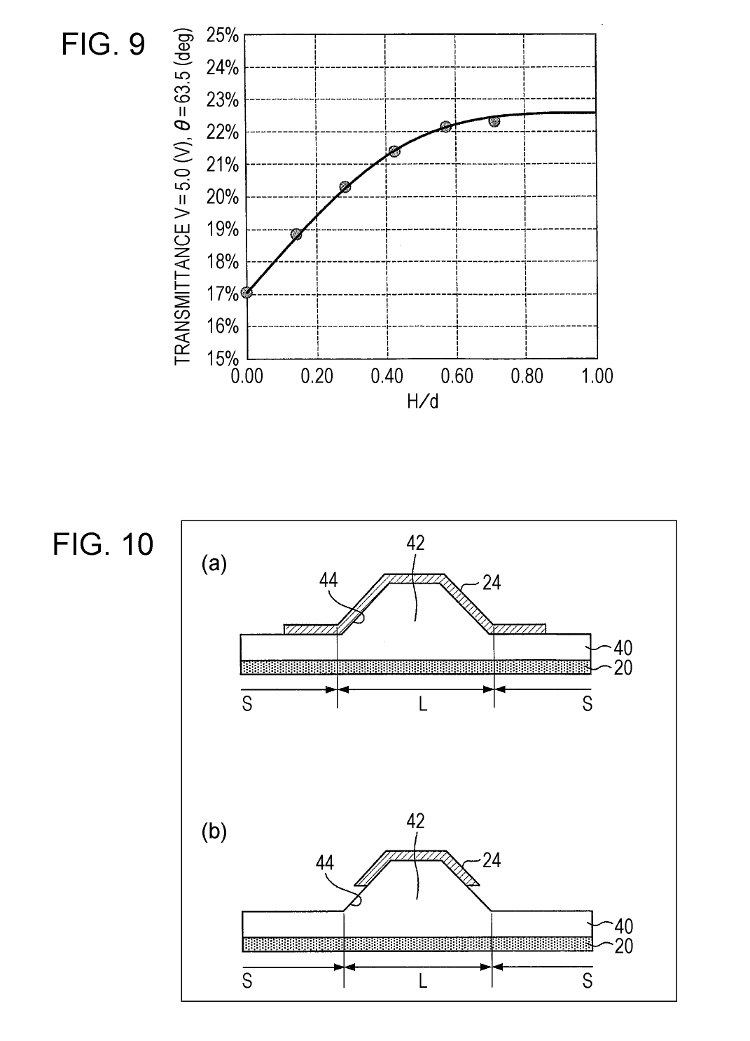

The relation between a ratio of convex projection height H/cell gap d and transmittance is described below with reference to FIGS. 8 and 9. FIGS. 8 and 9 are each a graph depicting the relation between the ratio of convex projection height H/cell gap d and transmittance. FIG. 8 represents the case of L:S=4.0:4.0 μm, and FIG. 9 represents the case of L:S=2.5:5.5 μm. The base angle θ=63.4 degrees and the applied voltage=5.0 V are common to both the cases of FIGS. 8 and 9.

As seen from FIGS. 8 and 9, an effect of increasing the transmittance from that in the related-art liquid crystal display device including the flat electrode structure is obtained at any value of the convex projection height, i.e., in the case of H/d>0. Such a transmittance improving effect is particularly high in the range of 0<H/d<0.6. At H/d≧0.6, the transmittance improving effect has a tendency to saturate.

Thus, the ratio of convex projection height H/cell gap d satisfies preferably H/d>0, which implies the presence of the convex structure at any height, and more preferably 0<H/d<0.6. Because the convex projection height H is always not larger than the cell gap d, H/d satisfies 1>H/d.

(Convex Projection and Electrode)

Coverage of the convex projection 42 with the electrode (each of the pixel electrode 24 and the counter electrode 26) is described below with reference to FIGS. 10(a) and 10(b). FIGS. 10(a) and 10(b) are each a partial sectional view of the liquid crystal display device of this embodiment; specifically, FIG. 10(a) illustrates the case where the electrode extends out of the convex projection 42, and FIG. 10(b) illustrates the case where the electrode does not fully cover the convex projection 42.

In a structure illustrated in FIG. 10(a) where the pixel electrode 24 extends out of the convex projection 42, the pixel electrode 24 not only covers the convex-projection side surfaces 44, but also extends up to a region of the electrode spacing S.

Even such a structure can also provide the effect of improving the transmittance in comparison with the related-art structure (flat electrode structure). In the above-described structure, however, the real electrode width L increases corresponding to the extension of the pixel electrode 24 up to the region of the electrode spacing S. Therefore, the transmittance improving effect reduces. This result is attributable to such a basic characteristic of the TBA mode that the transmittance reduces with an increase of the electrode width L.

On the other hand, in a structure illustrated in FIG. 10(b) where the pixel electrode 24 does not fully cover the convex projection 42, ends of the pixel electrode 24 are positioned on the convex-projection side surfaces 44.

Even such a structure can also provide the effect of improving the transmittance in comparison with the related-art structure (flat electrode structure). In the above-described structure, however, the occurrence of the oblique electric field reduces corresponding to the non-coverage of the convex projection 42 with the pixel electrode 24. Therefore, the transmittance improving effect reduces from that obtained with the structure where the entire surface of the convex projection 42 is just covered with the pixel electrode 24 without extending out of the convex projection 42.

As discussed above, while the transmittance improving effect is maximized when the convex projection 42 is just covered with the electrode (the pixel electrode 24 or the counter electrode 26), a higher transmittance than that in the related-art structure can be achieved even when the electrode excessively covers the convex projection 42, or even when the electrode does not fully cover the convex projection 42. The reason is that, insofar as the electrode is present at least in a part of the convex-projection side surface 44, the transverse electric field (oblique electric field) can be generated at a higher level than that in the related-art structure.

It is to be noted that FIGS. 10(a) and 10(b) illustrate the pixel electrode 24 as an example of the electrode, but the above discussion is similarly applied to the case where the electrode is the counter electrode 26.

(Dimensions of Convex Projection)

The height H and the base angle θ of the convex projection 42 have been described above in connection with the convex projection 42 having a trapezoidal shape.

However, the shape of the convex projection 42 is not limited to a trapezoid. The sectional shape of the convex projection 42 in a plane perpendicular to the array substrate 20 may be, e.g., trapezoidal, rectangular, or semi-elliptic.

Moreover, when the shape of the convex projection 42 is set to be trapezoidal or rectangular, it may be often not trapezoidal or rectangular in a strict sense of meaning.

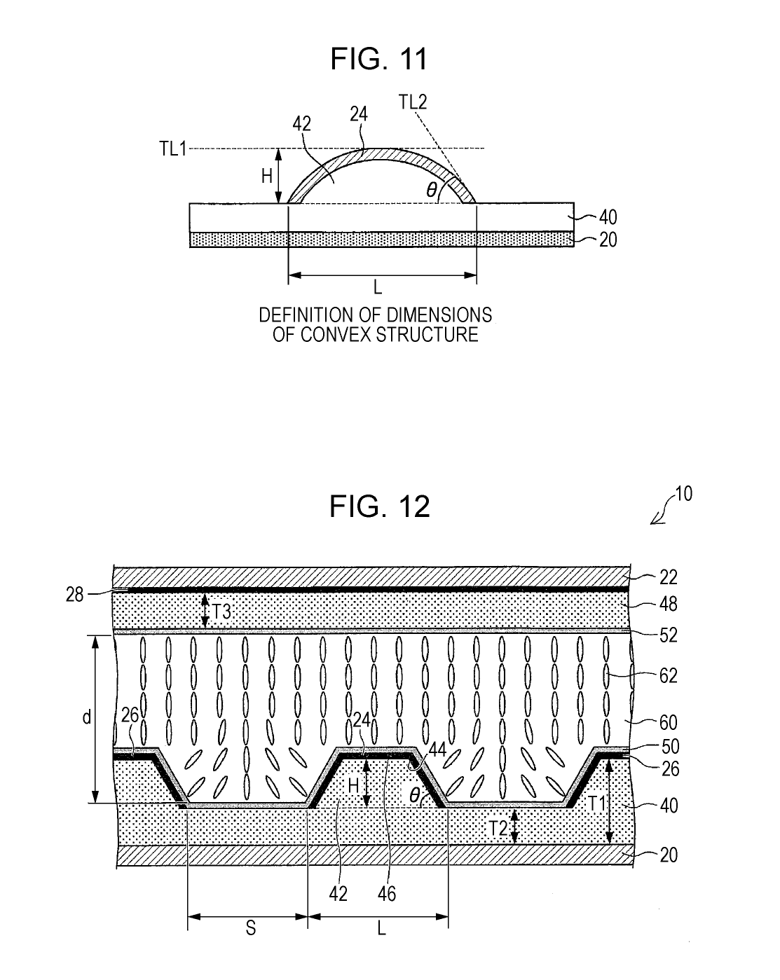

The convex projection height H and the base angle θ can be generalized as expressed in FIG. 11. FIG. 11 is a sectional view of the convex projection 42 to explain the dimensions of the convex projection 42.

First, as illustrated in FIG. 11, the convex projection height H can be defined as a distance between a portion where the convex projection 42 is not disposed and a first tangential line TL1. Here, the first tangential line TL1 is a tangential line drawn with respect to the highest portion of the convex projection 42 (the tangential line being parallel to the surface of the array substrate 20).

On the other hand, the base angle θ can be defined as an angle formed between the planar direction of the portion where the convex projection 42 is not disposed (i.e., the direction parallel to the surface of the array substrate 20) and a second tangential line TL2. Here, the second tangential line TL2 is a tangential line drawn with respect to the convex projection 42 to pass a point at which the convex projection 42 rises from the portion where the convex projection 42 is not disposed (the point corresponding to the end of the convex projection 42).

FIG. 11 is illustrated such that the convex projection height H and the base angle θ are defined on the basis of the pixel electrode 24 disposed on the surface of the convex projection 42.

In general, a film thickness of each of the pixel electrode 24 and the counter electrode 26 is much smaller than the height of the convex projection 42. Therefore, the convex projection height H and the base angle θ of the convex projection 42 can substantially be measured according to the measurement method illustrated in FIG. 11.

The electrode width L illustrated in FIG. 11 and so on is premised on that, when the electrode is disposed over the entire surface of the convex projection 42, a base width of the convex projection 42 is equal to the electrode width. Therefore, when the electrode does not fully cover the entire surface of the convex projection 42, or when the electrode extends out of the convex projection 42, the base width of the convex projection 42 and the electrode width are not the same. In such a case, L denoted in the drawings, etc. represents the base width of the convex projection 42.

### Embodiment 2

Another embodiment of the liquid crystal display device 10 according to the present invention will be described below with reference to FIGS. 12 to 19.

It is to be noted that, for convenience of explanation, members having the same functions as those in the drawings described in foregoing Embodiment 1 are denoted by the same signs and descriptions of those members are omitted.

The liquid crystal display device 10 of this embodiment differs from the liquid crystal display device 10 of Embodiment 1 in structure of the counter substrate 22. More specifically, in the liquid crystal display device 10 of foregoing Embodiment 1, only the vertical alignment film 52 is disposed on the counter substrate 22. On the other hand, in the liquid crystal display device 10 of this embodiment, an interlayer insulating film 48 and a second counter electrode 28 are disposed on the counter substrate 22 in addition to the vertical alignment film 52. In practice, the interlayer insulating film 48 and the second counter electrode 28 are disposed over an entire surface of the counter substrate 22, specifically over an entire display region of the liquid crystal display device 10.

Embodiment 2 is described in more detail below with reference to FIG. 12. FIG. 12 illustrates the liquid crystal display device 10 of this embodiment and is a sectional view illustrating a fundamental construction of the liquid crystal display device 10. In the liquid crystal display device 10 of this embodiment, as illustrated in FIG. 12, the second counter electrode 28, the interlayer insulating film 48, and the vertical alignment film 52 are disposed on the counter substrate 22 successively when viewed in a direction toward the liquid crystal layer 60.

The interlayer insulating film 40 disposed on the array substrate 20 and the above-mentioned interlayer insulating film 48 are made of the same material. Furthermore, the interlayer insulating film 48 is formed flat unlike the interlayer insulating film 40, and it has a film thickness T3 (thickness of the interlayer insulating film on the counter side).

(Alignment of Liquid Crystal Molecules)

Aligned states of the liquid crystal molecules 62 in the liquid crystal display device 10 of this embodiment are described below.

In the liquid crystal display device 10 of this embodiment, the second counter electrode 28 functioning as the counter electrode similarly to the aforementioned counter electrode 26 is disposed on the counter substrate 22. Therefore, an electric field is generated in a different way from that in the liquid crystal display device of the first embodiment illustrated in FIG. 2.

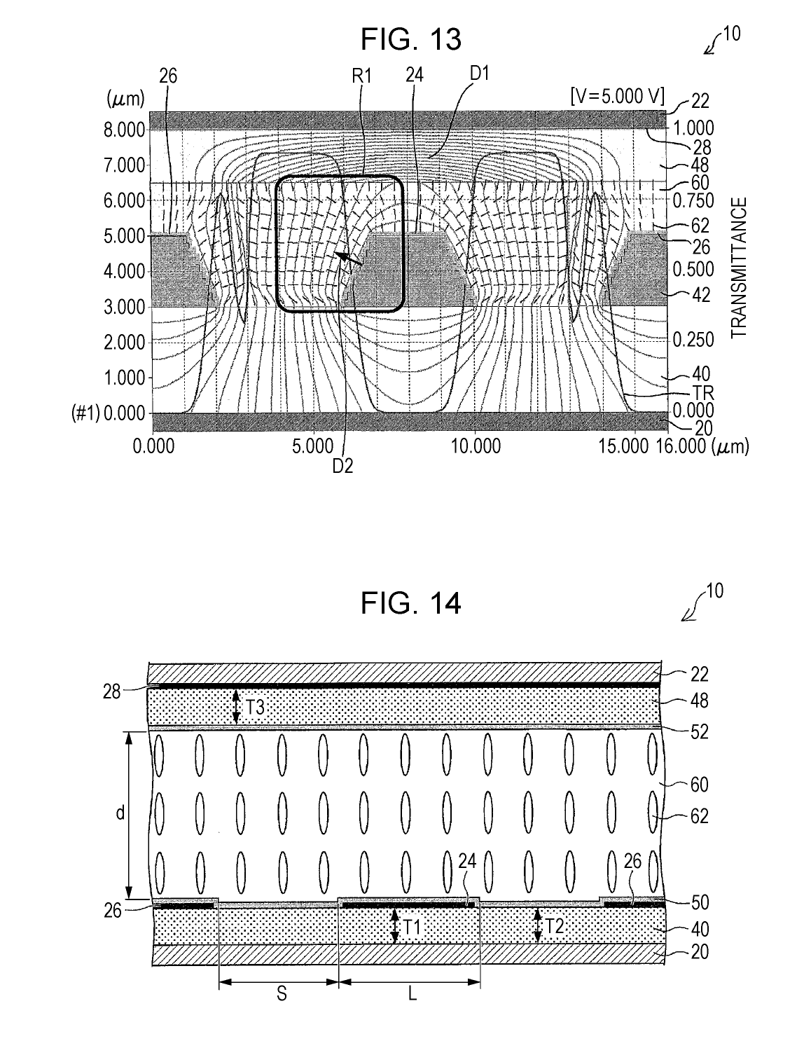

FIG. 13 is a sectional view of the liquid crystal display device 10, the view illustrating the aligned states of the liquid crystal molecules 62 in the liquid crystal display device 10 of this embodiment.

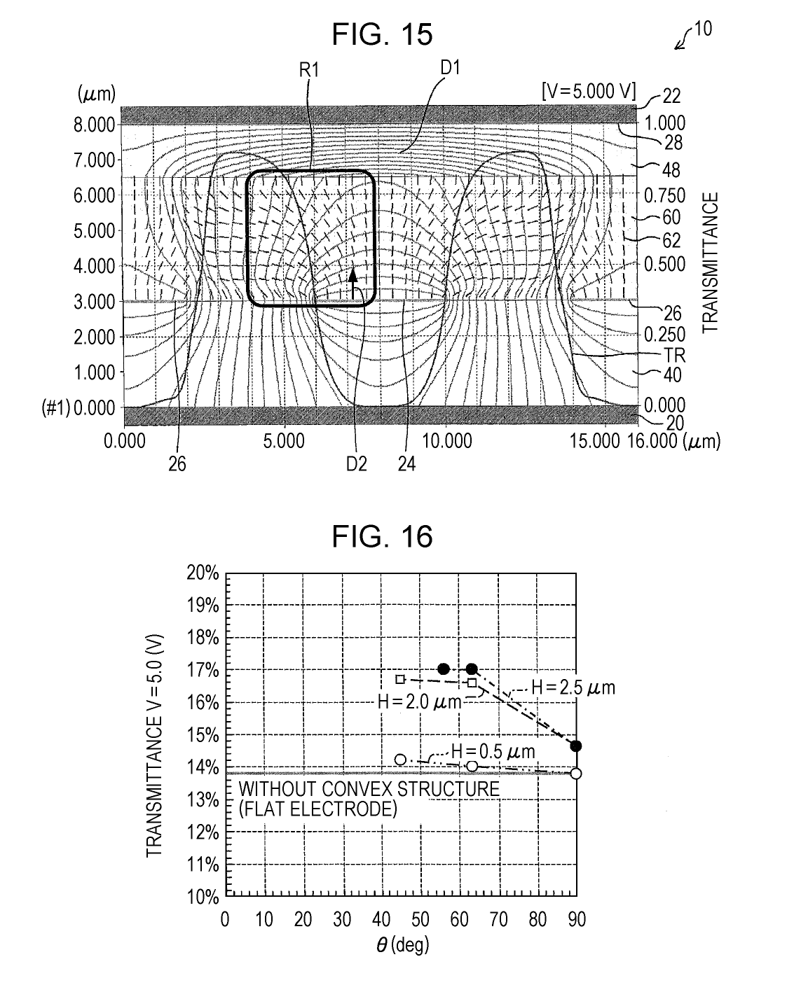

Moreover, FIG. 15 is a sectional view of a liquid crystal display device 10 of a comparative example, the view illustrating aligned states of liquid crystal molecules 62 in the liquid crystal display device 10 of the comparative example. FIG. 14 illustrates a construction of the liquid crystal display device 10 of the comparative example.

The liquid crystal display device 10 of the comparative example, illustrated in FIG. 14, and the liquid crystal display device 10 of this embodiment are common to each other in that the second counter electrode 28 is disposed on the counter substrate 22, but they are different in that the convex projection 42 is disposed on the array substrate 20 in the latter. Stated another way, in the liquid crystal display device 10 of the comparative example, the convex projection 42 is not disposed, and the interlayer insulating film 48 on the array substrate 20 has a flat surface.

In the liquid crystal display device 10 of this embodiment, as in the liquid crystal display device 10 of the first embodiment, transmittance near the convex projection 42 increases with the effect of the oblique electric field.

Particularly, in the region R1 above the electrode illustrated in FIG. 13, transmittance increases from that in the region R1 above the electrode illustrated in FIG. 15.

Such an improvement is apparent from comparing the transmittance curve TR in the region R1 above the electrode between FIG. 13 and FIG. 15. In other words, in the region R1 above the electrode located at the same relative position to the pixel electrode 24, the transmittance curve TR illustrated in FIG. 15 starts to fall from a position farther away from the pixel electrode 24, whereas the transmittance curve TR illustrated in FIG. 13 holds a high level up to a position closer to the pixel electrode 24.

Such an increase of the transmittance depends on the difference in the alignment direction of the liquid crystal molecules 62. Stated another way, in the liquid crystal display device 10 of the comparative example, as illustrated in FIG. 15, the direction D2 of the electric field is vertical in the region R1 above the electrode, and therefore the liquid crystal molecules 62 are hard to tilt toward the transverse direction.

In contrast, in the liquid crystal display device 10 of this embodiment, the direction D2 of the electric field in the region R1 above the electrode, illustrated in FIG. 13, is more apt to generate in the transverse (oblique) direction. Therefore, the liquid crystal molecules 62 are more apt to tilt toward the transverse direction in the region R1 above the electrode. Accordingly, transmittance increases in the region R1 above the electrode.

(Near Electrode Interface)

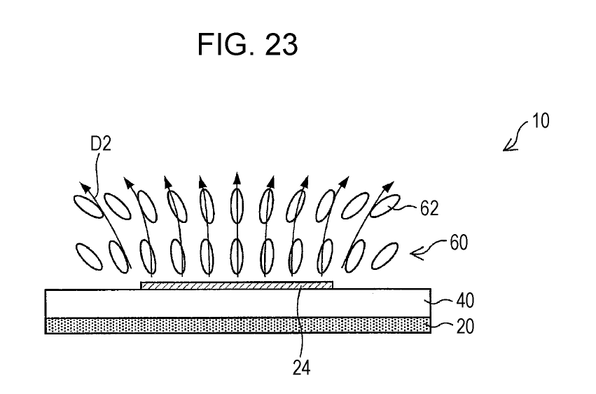

The aligned states of the liquid crystal molecules near the electrode interface in this embodiment and in the comparative example are substantially similar to those illustrated in FIGS. 3 and 23, respectively.

More specifically, in the liquid crystal display device 10 illustrated in FIG. 12, the electric field in the transverse (oblique) direction is more apt to generate near the electrode interface and the liquid crystal molecules 62 to be aligned in the same direction as the direction D2 of the electric field are also more apt to orient in the transverse direction, as illustrated in FIG. 3.

On the other hand, in the liquid crystal display device 10 illustrated in FIG. 14, the direction D2 of the electric field near the electrode interface is close to the vertical direction, as illustrated in FIG. 23. Therefore, the liquid crystal molecules 62 are harder to tilt.

Thus, in the liquid crystal display device 10 of this embodiment, the transmittance in the region R1 above the electrode increases.

(Change of Transmittance)

The relation between the exemplary dimensions and transmittance is described below with reference to FIGS. 16 to 19.

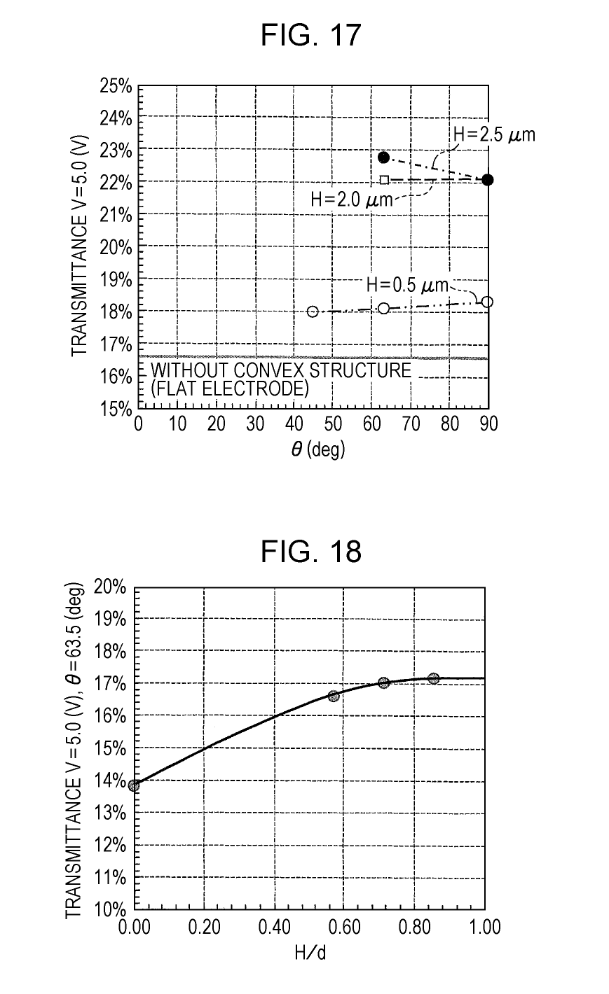

FIGS. 16 and 17 correspond respectively to FIGS. 4 and 5 in Embodiment 1. FIG. 16 is a graph depicting relation between the base angle θ and transmittance at L:S=4.0:4.0 μm. FIG. 17 is a graph depicting relation between the base angle θ and transmittance at L:S=2.5:5.5 μm.

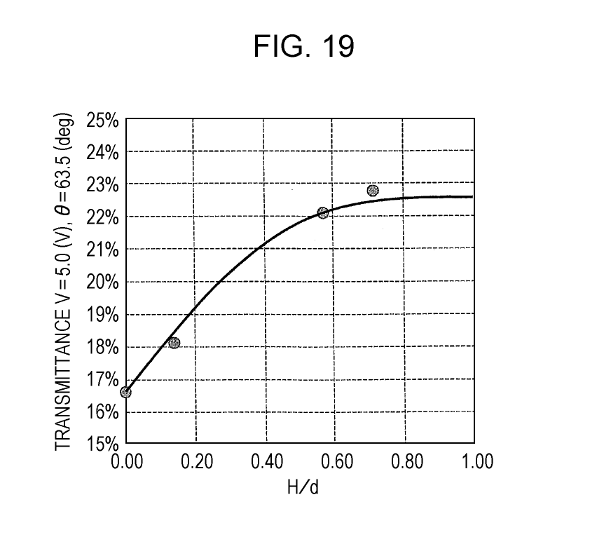

Furthermore, FIGS. 18 and 19 correspond respectively to FIGS. 8 and 9 in Embodiment 1. FIG. 18 is a graph depicting relation between the ratio of convex projection height H/cell gap d and transmittance at L:S=4.0:4.0 μm. FIG. 19 is a graph depicting relation between the ratio of convex projection height H/cell gap d and transmittance at L:S=2.5:5.5 μm.

The construction of the liquid crystal display device, materials used therein, etc. are similar to those in Embodiment 1 unless otherwise specified.

As seen from FIGS. 16 to 19, there is a tendency that the transmittance increases with an increase of the convex projection height H as in Embodiment 1.

Regarding the relation between the ratio of convex projection height H/cell gap d and transmittance, it is also seen that, as in Embodiment 1, the transmittance increases at any value of the convex projection height H (H/d>0) from that in the related-art liquid crystal display device including the flat electrode structure. Stated with respect to the base angle θ, the transmittance increases at any value of the base angle θ.

Such a transmittance improving effect is large particularly in a range of 0<H/d<0.6. Furthermore, the transmittance improving effect has a tendency to saturate at H/d≧0.6.

(Shape of Convex Projection)

The case of the convex projection 42 having the trapezoidal sectional shape has been described above. However, the shape of the convex projection 42 is not limited to a trapezoid, and it may variously be modified.

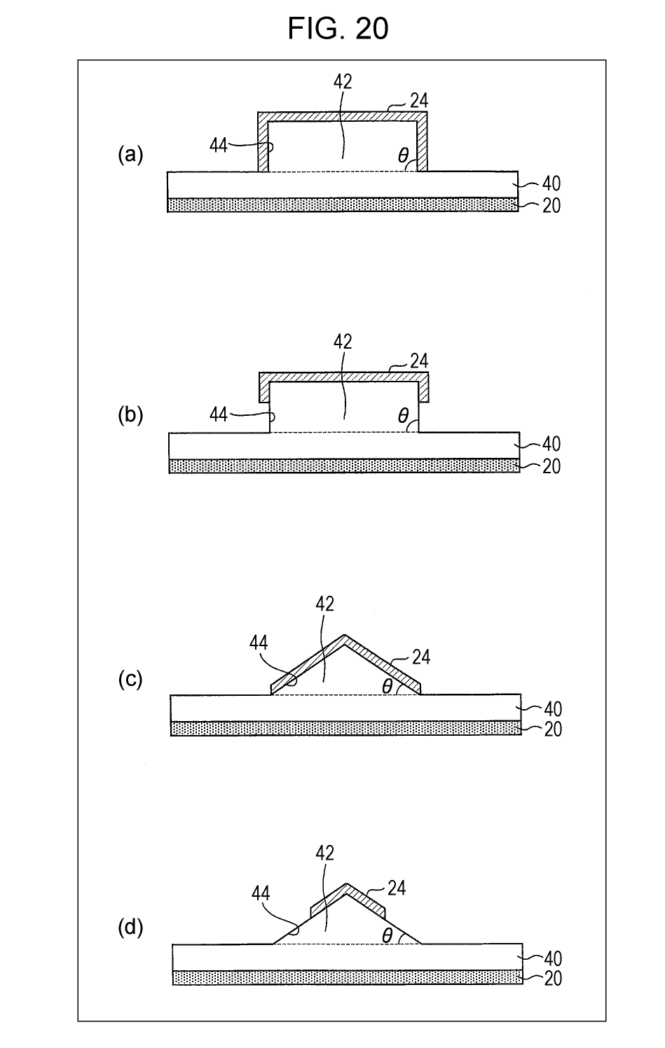

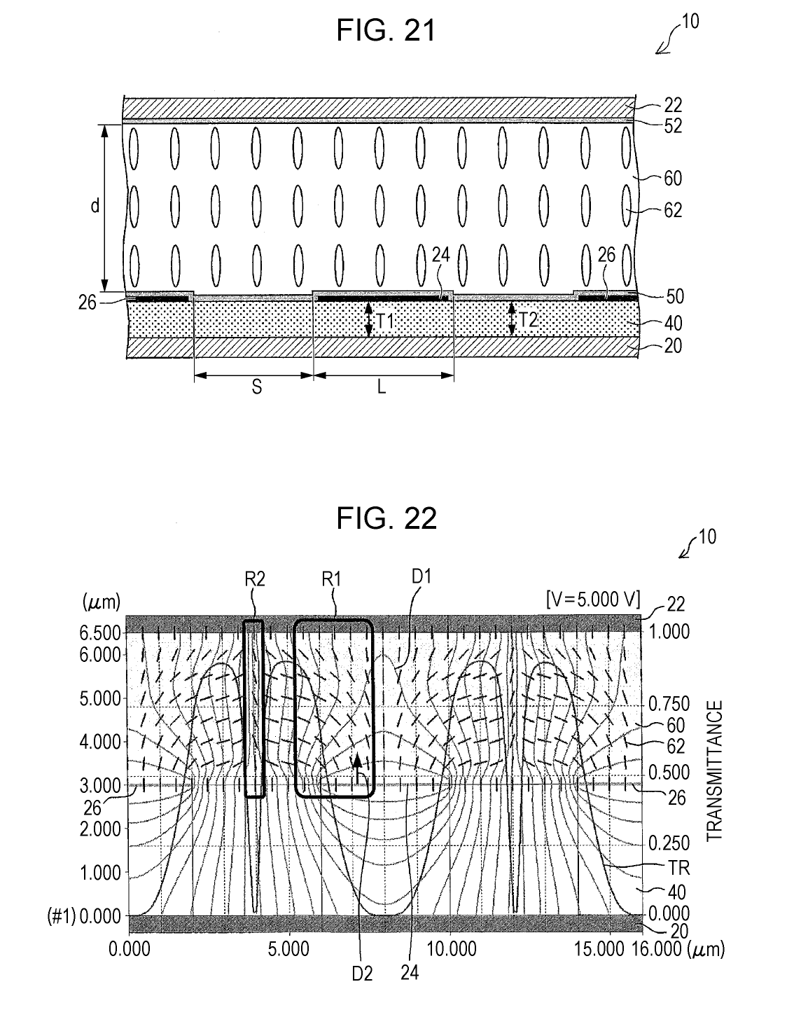

FIGS. 20(a) to 20(d) illustrate convex projections 42 having other shapes than a trapezoid. FIG. 20 is a sectional view of the liquid crystal display device; specifically, FIGS. 20(a) and 20(b) illustrate the case where the convex projection is rectangular, and FIGS. 20(c) and 20(d) illustrate the case where the convex projection is triangular.

As illustrated in FIG. 20, the convex projection 42 may have various sectional shapes including, e.g., a rectangle and a triangle, as well as a trapezoid.

When the convex projection 42 is rectangular as illustrated in FIGS. 20(a) and 20(b), the base angle θ is 90 degrees.

When the convex projection 42 is rectangular, the transverse electric field is apt to generate from the convex-projection side surface 44 of one convex projection 42 toward the convex-projection side surface 44 of another adjacent convex projection 42. Therefore, the liquid crystal molecules 62 are apt to tilt and the transmittance is apt to increase.

When the convex projection 42 is triangular as illustrated in FIGS. 20(c) and 20(d), the oblique electric field generates from the convex-projection side surface 44 substantially in the same manner as in the above-described case where the convex projection 42 is trapezoidal. Therefore, the transmittance increases as in the case where the convex projection 42 is trapezoidal.

It is to be noted that a range of the base angle θ when the convex projection 42 is triangular is substantially similar to that in the above-described case where the convex projection 42 is trapezoidal. However, the base angle θ<90 degrees is held when the convex projection 42 is triangular.

(Coverage with Electrode)

Even when the convex projection 42 is not trapezoidal, the electrode (each of the pixel electrode 24 and the counter electrode 26) is just required, as in the above-described case, to cover at least a part of the convex-projection side surface 44. There is no particular limitation on how the convex projection 42 is to be covered with the electrode.

FIGS. 20(b) and 20(d) illustrate arrangements in which the pixel electrode 24 covers only a part of the convex-projection side surface 44 when the convex projection 42 is rectangular and triangular, respectively.

In addition, the convex projection 42 is not always required to be formed using the interlayer insulating film, and it may be formed of a material other than the material of the interlayer insulating film. Examples of the material other than that of the interlayer insulating film include SiO_{X} and SiN_{X} (X is an integer).

The present invention is not limited to the above-described embodiments, and the present invention may variously be modified within the scope defined in claims. Other embodiments obtaining by combining as appropriate the technical means disclosed in the above different embodiments with each other are also involved in the technical scope of the present invention.

In the liquid crystal display device of the present invention, preferably,

the side surface of the projection includes a portion that is inclined from the direction perpendicular to the substrates.

With that feature, since the side surface is inclined, the transverse electric field is more apt to generate in the region above the electrode than in the case where the side surface is perpendicular. As a result, transmittance can further be increased.

Furthermore, since the side surface is inclined, the transmittance improving effect can be obtained even when the electrode width is comparatively wide.

In the liquid crystal display device of the present invention,

given that a height of the projection is H, a base width of the projection is L, and a base angle of the projection is θ,

the base angle θ may satisfy tan⁻¹(2H/L)≦θ≦90 degrees.

The liquid crystal display device of the present invention is featured in that,

given that a height of the projection is H and a thickness of the liquid crystal layer at a position where the projection is not disposed is d,

a ratio H/d of the height H to d satisfies 0<H/d<1.

In the liquid crystal display device of the present invention, preferably,

the ratio H/d satisfies 0.6≦H/d<1.

With that feature, the projection is disposed at least at a height equal to or more than a minimum height. Therefore, the transverse (oblique) electric field is apt to generate, thus resulting in higher transmittance.

Furthermore, when the ratio H/d satisfies 0.6≦H/d<1, an increase extent of the transmittance can be made larger.

In the liquid crystal display device of the present invention,

a sectional shape of the projection may be any one of trapezoidal, rectangular, and semi-elliptic shapes.

The term “sectional shape” implies a sectional shape of the projection when viewed in a plane perpendicular to the substrate on which the projection is disposed.

In the liquid crystal display device of the present invention,

the electrode may cover an entire surface of the projection.

With the above-described feature, the entire surface of the projection, including the side surfaces thereof, is covered with the electrode. Therefore, the transverse (oblique) electric field is more apt to generate near the electrode interface, and the transmittance improving effect can be obtained at a higher level.

In the liquid crystal display device of the present invention,

an active element may be disposed on one of the pair of substrates on which the projection is disposed.

With the above-described feature, the projection can be formed by employing an interlayer insulating film disposed on the array substrate, i.e., the substrate on which the projection is disposed. Accordingly, the formation of the projection is facilitated.

In the liquid crystal display device of the present invention,

a counter electrode may be disposed on a second substrate differing from one of the pair of substrates on which the projection is disposed.

In the liquid crystal display device of the present invention,

a flat layer formed of a dielectric substance may be disposed on the second substrate, and

the counter electrode may be disposed between the second substrate and the flat layer over an entire display region.

With the above-described feature, the counter electrode is disposed on the substrate opposed to the substrate on which the projection is disposed.

Thus, even when the side surface of the projection is inclined at an angle close to a vertical angle, an electric field generated in the region above the electrode can be bent toward the transverse (oblique) direction with an interaction between the counter electrode on the second substrate side and the pixel electrode on the first substrate side.

Therefore, the transmittance is more apt to increase even when the side surface of the projection is inclined at an angle close to a vertical angle, i.e., inclined closely perpendicular to the substrate.

### INDUSTRIAL APPLICABILITY

Since the present invention is concerned with a liquid crystal display device having increased transmittance, the present invention can suitably be applied to displays in which high quality is required.

### REFERENCE SIGNS LIST

10 liquid crystal display device
20 array substrate (substrate)
22 counter substrate (substrate)
24 pixel electrode (electrode)
26 counter electrode (electrode)
28 second counter electrode
40 interlayer insulating film
42 convex projection (projection)
44 convex-projection side surface (side surface of convex projection)
46 convex-projection upper surface
48 interlayer insulating film
50 alignment film
52 alignment film
60 liquid crystal layer
62 liquid crystal molecules
110 display device
112 substrate
114 interlayer insulating film
116 pixel electrode
118 counter electrode
120 recess
S electrode spacing
L electrode width
d cell gap
D1 equipotential line
D2 direction of electric field
R1 region above electrode
R2 region at middle between electrodes
H convex projection height
T1 thickness of interlayer insulating film under electrode
T2 thickness of interlayer insulating film between the electrodes

T3 thickness of interlayer insulating film on counter side
TR transmittance curve
θ base angle
TL1 first tangential line
TL2 second tangential line

1. A liquid crystal display device comprising a pair of substrates and a liquid crystal layer sandwiched between the pair of substrates,
the liquid crystal layer containing liquid crystal molecules that are initially aligned in a direction perpendicular to the substrates,
the liquid crystal display device displaying an image by controlling alignment of the liquid crystal molecules with a transverse electric field,
wherein a projection formed of a dielectric substance is disposed on at least one of the pair of substrates, and
an electrode is disposed to cover at least a part of a side surface of the projection.

2. The liquid crystal display device according to claim 1, wherein the side surface of the projection includes a portion that is inclined from the direction perpendicular to the substrates.

3. The liquid crystal display device according to claim 1, wherein, given that a height of the projection is H, a base width of the projection is L, and a base angle of the projection is θ,
the base angle θ satisfies tan−1(2H/L)≦θ≦90 degrees.

4. The liquid crystal display device according to claim 1, wherein, given that a height of the projection is H and a thickness of the liquid crystal layer at a position where the projection is not disposed is d,
a ratio H/d of the height H to d satisfies 0<H/d<1.

5. The liquid crystal display device according to claim 4, wherein the ratio H/d satisfies 0.6≦H/d<1.

6. The liquid crystal display device according to claim 1, wherein a sectional shape of the projection is any one of trapezoidal, rectangular, and semi-elliptic shapes when viewed in a plane perpendicular to the substrate on which the projection is disposed.

7. The liquid crystal display device according to claim 1, wherein the electrode covers an entire surface of the projection.

8. The liquid crystal display device according to claim 1, wherein an active element is disposed on one of the pair of substrates on which the projection is disposed.

9. The liquid crystal display device according to claim 1, wherein a counter electrode is disposed on a second substrate differing from one of the pair of substrates on which the projection is disposed.

10. The liquid crystal display device according to claim 9, wherein a flat layer formed of a dielectric substance is disposed on the second substrate, and
the counter electrode is disposed between the second substrate and the flat layer over an entire display region.
